(19) United States
(12) Patent Application Publication
(10) Pub. No.: US 2014/0087275 A1
(43) Pub. Date: Mar. 27, 2014

(54) Alkaline Membrane Fuel Cell

(71) Applicants: Jose Viriato Coelho Vargas, Tallahassee, FL (US); Jose Eduardo Ferreira da Costa Gardolinski, Tallahassee, FL (US); Juan Carlos Ordonez, Tallahassee, FL (US); Zohrob Havsapian, Tellahassee, FL (US)

(72) Inventors: Jose Viriato Coelho Vargas, Tallahassee, FL (US); Jose Eduardo Ferreira da Costa Gardolinski, Tallahassee, FL (US); Juan Carlos Ordonez, Tallahassee, FL (US); Zohrob Havsapian, Tellahassee, FL (US)

(21) Appl. No.: 14/033,915

(22) Filed: Sep. 23, 2013

Related U.S. Application Data
(60) Provisional application No. 61/703,915, filed on Sep. 21, 2012.

(51) Int. Cl. H01M 8/10

(52) U.S. Cl. CPC H01M 8/1016
USPC 429/409

(57) ABSTRACT

A fuel cell design which incorporates an alkaline membrane. The membrane is preferably made of specially selected commercial filter paper. The membrane is impregnated with a solution of water and potassium hydroxide. The membrane provides a novel, inexpensive method of introducing potassium hydroxide into the cell and containing it in the active area. Flexible carbon fiber films are used as electrodes. These are coated with a catalyzing film of nickel, iron, and/or cobalt, rather than a precious metal such as platinum.

### CROSS-REFERENCES TO RELATED APPLICATIONS

This non-provisional patent application claims the benefit of an earlier-filed provisional application. The earlier application listed the same inventors and was assigned Ser. No. 61/703,915.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of fuel cells. More specifically, the invention comprises an alkaline membrane fuel cell using an exchange membrane made of commercial filter paper.

2. Description of the Related Art

Fuel cells are regarded as an important stepping stone in the development of a “hydrogen economy.” Fuel cell technology evolved rapidly during the late 1950's and continued through the 1960's. The evolution of the technology was significant to long-term spaceflight, since the production of electrical energy using conventional storage batteries was not sufficient.

The early fuel cells were very expensive devices. The cost of the technology has come down significantly, with power generation and motor vehicle applications now being commercialized. However, the cost of fuel cells is still quite high compared to more conventional technologies.

Traditional fuel cells use a proton exchange membrane such as NAFION (a product of DuPont, USA). A NAFION membrane is used in the construction of a polymer electrolyte membrane fuel cell (“PEMFC”). NAFION is an acid polymeric membrane. The acid environment typically requires the use of precious metal catalysts, such as platinum or palladium. The supply of such catalysts is obviously limited, which limits the scalability of PEMFC's. Both the NAFION membrane and the precious metal catalyst(s) also add significantly to the total cost of the fuel cell.

Nickel, iron, and cobalt have catalytic potentials similar to platinum, and are obviously much cheaper. However, these materials cannot be used in the construction of a PEMFC because they cannot withstand the acidic environment. On the other hand, if an alkaline fuel cell membrane can be developed, these catalysts could be used. Thus, the development of an alkaline membrane fuel cell offers significant advantages.

### BRIEF SUMMARY OF THE INVENTION

The present invention comprises a fuel cell design which incorporates an alkaline membrane. The membrane is preferably made of specially selected commercial filter paper. The membrane is impregnated with a solution of water and potassium hydroxide. The membrane provides a novel, inexpensive method of introducing potassium hydroxide into the cell and containing it in the active area. Flexible carbon fiber films are used as electrodes. These are coated with a catalyzing film of nickel, iron, and/or cobalt.

The fuel cell may be operated using gaseous hydrogen and oxygen as the inputs. Alternatively, an absorbing reactor can be added to permit the substitution of air for oxygen.

### BRIEF DESCRIPTION OF THE SEVERAL VIEWS OF THE DRAWINGS

FIG. 1 is an exploded perspective view showing a fuel cell made according to the present invention.

FIG. 2 is a perspective view, showing the assembly of FIG. 1 in an assembled state.

FIG. 3 is a schematic view, showing the operation of the assembled fuel cell.

REFERENCE NUMERALS IN THE DRAWINGS

| | | | |
|---|---|---|---|
| 10 | alkaline membrane fuel cell | 12 | alkaline membrane electrolyte |
| 14 | fuel manifold | 16 | oxidizer manifold |
| 18 | anode | 20 | cathode |
| 22 | fuel inlet | 24 | fuel outlet |
| 26 | oxidizer inlet | 28 | oxidizer outlet |
| 30 | flow channels | 32 | membrane electrode assembly |
| 34 | fuel gas channel | 36 | anode diffusion layer |
| 38 | anode reactive layer | 40 | cathode reactive layer |
| 42 | cathode diffusion layer | 44 | oxidizer gas channel |

### DETAILED DESCRIPTION OF THE INVENTION

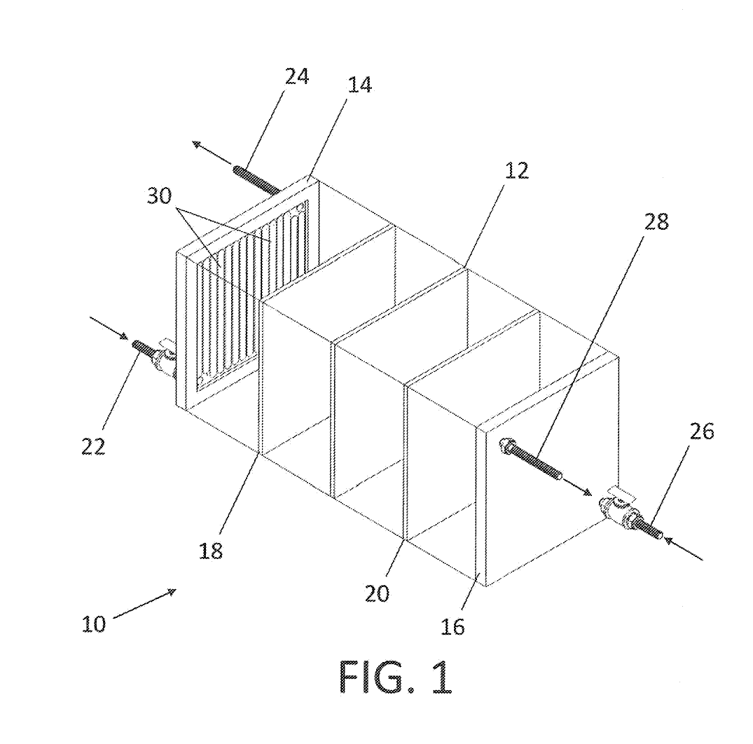

This description begins by explaining the basic components and construction of the present invention. More detail will be provided subsequently. Fuel cells have traditionally been constructed by sandwiching together the various components. The present invention is preferably assembled using this known technique, though other techniques may be used as well. FIG. 1 shows the components of alkaline membrane fuel cell 10 in an exploded state. Fuel manifold 14 lies to the left in the view. Proceeding from left to right, the other components are anode 18, alkaline membrane electrolyte 12, cathode 20, and oxidizer manifold 16.

Fuel manifold 14 receives a gaseous fuel (such as hydrogen) through fuel inlet 22. The fuel is circulated through a plurality of flow channels 30. which may assume any desired configuration. Parallel flow channels are depicted, but a serpentine flow path may also be used. Other known configurations may be substituted as well. Excess fuel leaves the fuel manifold via fuel outlet 24.

Anode 18 is made by electrodepositing nickel, iron, and/or cobalt on a permeable and flexible carbon film. Such films are known to those in the field, as they are similar to designs used to carry precious metal catalysts for prior art fuel cells. They provide electrical conductivity and suitable porosity.

Prior art electrolyte membranes used in the field of fuel cells have been made of sophisticated materials such as NAFION. The present invention employs commercially-available cellulosic filter paper having a porosity in a selected range. Alkaline membrane 12 is preferably comprised of selected commercial filter paper having a porosity within the range of 5% to 30%. In this context the term “porosity” is defined to mean the ratio of the volume of the pores or interstices in the filter paper to the total volume—stated as a percentage.

The filter paper membrane is saturated with a potassium hydroxide solution (potassium hydroxide in water). The mass fraction of the KOH in the electrolyte solution is preferably held between about 10% and about 50% for maximum ionic conductivity.

Cathode 20 is made in the same manner as anode 18. It is preferably a flexible carbon film with an added layer of one or more catalysts. Oxidizer manifold 16 receives an oxidizer such as oxygen. The oxidizer manifold includes flow channels as for the fuel manifold, though these are facing away from the viewer and not visible in FIG. 1. The oxidizer manifold receives a gaseous oxidizer through oxidizer inlet 28 and excess oxidizer flows out of the manifold through oxidizer outlet 28.

The components shown in FIG. 1 must be compressed together to function. A specially designed square polymeric gasket is used to seal the membrane electrode assembly (“MEA,” which is the assembly of alkaline membrane 12, anode 18, and cathode 20). The components may be pressed together using threaded fasteners or other suitable hardware. In the embodiment shown, the fuel and oxidizer plates are rigid structures which may be used to force the other components against each other. Elaborate seals are not needed, as the use of the KOH aqueous solution does not produce the acidic environment found in prior art proton exchange membrane (“PEM”) fuel cells.

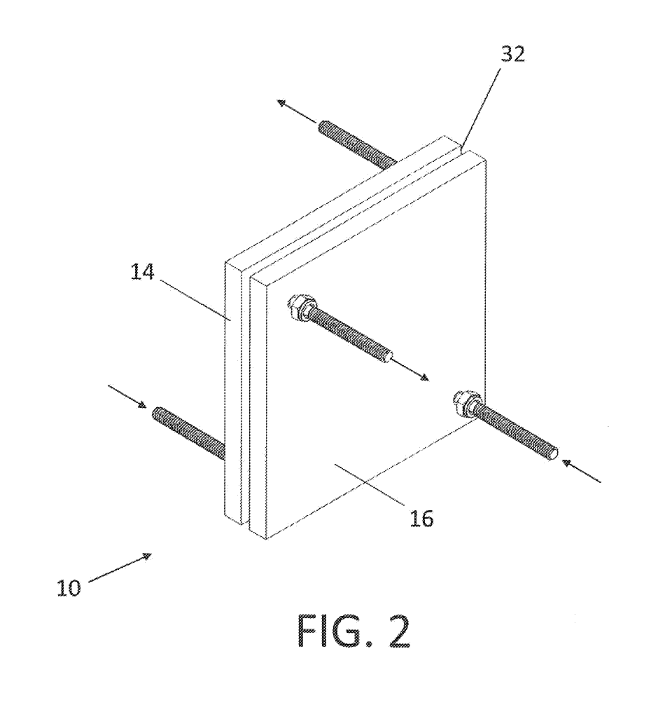

FIG. 2 shows the components mated together. The hardware used to compress the components together is not shown in the view. However, the reader may easily observe how the two manifolds (fuel manifold 14 and oxidizer manifold 16) may be used to “sandwich” membrane electrode assembly 32.

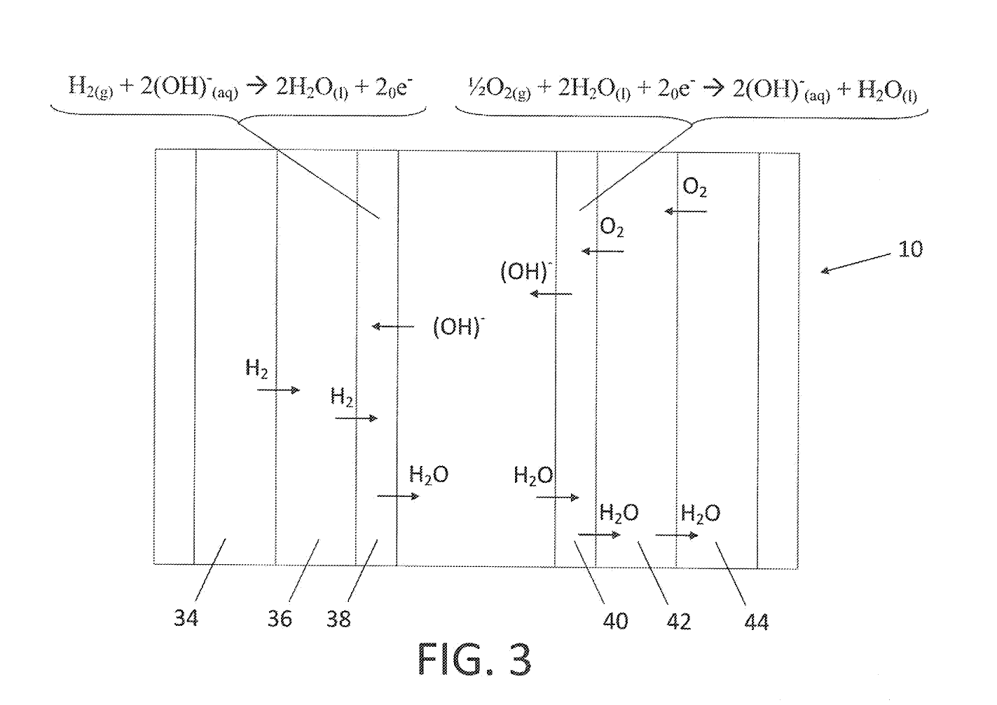

FIG. 3 shows a schematic depiction of the assembled fuel cell in an operating state along with the chemical expressions that describe the reactions occurring within the cell. Gaseous hydrogen is fed through fuel gas channel 34 in the fuel manifold. Gaseous oxygen is fed through oxidizer gas channel 44 in the oxidizer manifold.

Alkaline membrane 12 contains the potassium hydroxide electrolyte. As described previously, the membrane is made of specially selected commercial filter paper. It provides an inexpensive method of introducing potassium hydroxide electrolyte into the cell and containing it within the active area of the cell. This approach is substantially cheaper than the traditional approach employing polymer membranes and/or liquid electrolytes. The commercial filter paper is preferably selected to have porosity values between 5 and 30% for maximum performance. It is preferably maintained within this range using feedback-controlled humidifiers. These humidifiers regulate the amount of KOH aqueous solution to make sure that the membrane does not dry out and that the mass fraction of the aqueous solution remains within the desired range.

The temperatures produced by the reactions are similar to those produced within a PEM fuel cell, so the same temperature and reactant control techniques may be used. The assembly of the fuel cell can be as thin and efficient as a PEM cell, while using cheaper materials (The catalysts and the membrane are cheaper).

The permeable carbon fiber films used for the anode and cathode are similar to those used in prior art fuel cells involving precious metal catalysts. However, rather than precious metals, the carbon fiber films are coated with nickel, iron, and/or cobalt layer(s). Catalyst efficiency using nickel, iron, and/or cobalt is comparable to the efficiency obtained using platinum coatings in prior art fuel cells.

The mass fraction of potassium hydroxide in the electrolyte is preferably optimized between 10 and 50% for increased ionic conductivity in the presence of the cellulosic membrane.

FIG. 3 depicts the reactions occurring within the cell. The half-cell reactions occurring within the fuel cell may be written as:

$${H}_{2 ( g )} + 2 {OH}_{( aq )}^{-} {\to }^{yields} 2 {H}_{2} {O}_{( l )} + 2 {e}^{-} ( anode side )$$

$$\frac{1}{2} {O}_{2 ( g )} + 2 {H}_{2} {O}_{( l )} + 2 {e}^{-} {\to }^{yields} 2 {OH}_{( aq )}^{-} + {H}_{2} {O}_{( l )} ( cathode side )$$

The hydroxyl ions are the conducting species in the electrolyte. The equivalent overall cell reaction may be written as:

H₂+½O₂→H₂O+electricity+heat

Since potassium hydroxide has the highest conductance among the alkaline hydroxides, it is the preferred electrolyte. The reactions are graphically represented in FIG. 3. The reader will observe the diatomic oxygen flowing from right to left and being transformed into a hydroxyl ion as it passes from oxidizer gas channel 44, through cathode diffusion layer 42, and cathode reactive layer 40.

The diatomic hydrogen flows from left to right and reacts to form water as it flows from fuel gas channel 24, through anode diffusion layer 36, and into anode reactive layer 38. The water thus formed passes through cathode reactive layer 40, cathode diffusive layer 42, and ultimately out of the device. The reactions thus depicted result in a free electron flow from the fuel side of the membrane, through an attached load and then to the oxidant side. The electrical circuit used to harvest this flow is not depicted as it is well understood by those skilled in the art.

The fuel cell depicted in FIG. 3 uses gaseous hydrogen and gaseous oxygen. It is also possible to substitute air for oxygen, provided certain modifications are made. A carbon dioxide absorbing reactor (with a calcium carbonate substrate) permits operation of the fuel cell using ambient air rather than purified oxygen. It may also be possible to use hydrocarbon fuels rather than pure hydrogen.

As stated previously, the inventive design is expected to be as thin and efficient as existing PEMFC designs. It is also possible to combine the cells in the same manner as known for PEMFC designs. For example, one can stack multiple cells and connect them in series to increase the overall voltage produced. However, unlike prior art PEMFC designs, the present invention uses relatively inexpensive and widely available catalyst and membrane materials. It may therefore be scaled at a much lower cost.

As those skilled in the art will know, an electrical load to be powered by the inventive fuel cell should be connected between the anode and the cathode. Charge collecting components may be used to facilitate the connection of the load. If the individual cells are stacked to increase voltage—as is likely the case for most embodiments—a master anode and master cathode may be provided for the electrical circuit.

Automated control of a completed “stack” of fuel cells made according to the present invention may be provided by closed-loop software running on a computing device. Appropriate sensors are provided to monitor the functions of the fuel cell. The sensor set would preferably include: (1) electrolyte humidity sensors at one or more points across the electrolyte; (2) one or more electrolyte temperature sensors; (3) one or more reactant flow sensors; (4) one or more reactant input temperature sensors; and (5) one or more reactant output temperature sensors.

Although the preceding description contains significant detail, it should properly be viewed as disclosing examples of the inventions many possible embodiments. As an example, the use of a “slacked” assembly where plate-like elements are compressed together is only one way of physically realizing the inventive fuel cell. One could construct the cell using non-plate geometry. As a second example, the diffusion layer for the reactants could be made using techniques other than the linear flow channels shown in the drawings. Many other variations within the scope of the present invention will, occur to those skilled in the art. Accordingly, the scope of the invention should be fixed by the following claims rather than any specific embodiments presented.

Having described our invention, we claim:

1. A method of producing an electrical potential using a fuel and an oxidizer, comprising:
a. providing an anode diffusion layer;
b. providing an anode coated by a catalyst, wherein said anode lies next to said anode diffusion layer;
c. providing a cathode diffusion layer;
d. providing a cathode coated by a catalyst, wherein said cathode lies next to said cathode diffusion layer;
e. providing an alkaline membrane electrolyte, wherein said alkaline membrane electrolyte lies between said anode and said cathode;
f. wherein said alkaline membrane electrolyte is made of filter paper having a porosity between 5% and 30% by volume;
g. wherein said alkaline membrane electrolyte is wetted by an aqueous potassium hydroxide solution having a mass fraction of potassium hydroxide between 10% and 50%;
h. providing a gaseous fuel to said anode diffusion layer; and
i. providing a gaseous oxidizer to said cathode diffusion layer.

2. A method of producing an electrical potential as recited in claim 1, further comprising providing a humidifier that regulates the saturation of said alkaline membrane electrolyte with said aqueous potassium hydroxide solution.

3. A method of producing an electrical potential as recited in claim 2, wherein said humidifier is under automatic control.

4. A method of producing an electrical potential as recited in claim 1, wherein a flow of said gaseous fuel and a flow of said gaseous oxidizer is regulated to provide a desired reaction rate.

5. A method of producing an electrical potential as recited in claim 4, wherein said regulation of said flows is done automatically.

6. A method of producing an electrical potential as recited in claim 2, wherein said fuel is hydrogen.

7. A method of producing an electrical potential as recited in claim 6, wherein said oxidizer is oxygen.

8. A method of producing an electrical, potential as recited in claim 7, wherein said oxygen is taken from a supply of air.

9. A method of producing an electrical potential as recited in claim 1, wherein each of said catalysts is selected from the group consisting of nickel, iron, and cobalt.

10. A method of producing an electrical potential as recited in claim 7, wherein each of said catalysts is selected from the group consisting of nickel, iron, and cobalt.

11. A method of producing electricity using a fuel and an oxidizer, comprising;
a. providing an anode diffusion layer;
b. providing an anode coated by a catalyst, wherein said anode lies next to said anode diffusion layer;
c. providing a cathode diffusion layer;
d. providing a cathode coated by a catalyst, wherein said cathode lies next to said cathode diffusion layer;
e. providing an alkaline membrane electrolyte made of porous filter paper, wherein said alkaline membrane electrolyte lies between said anode and said cathode;
f. said alkaline membrane electrolyte being wetted by an aqueous potassium hydroxide solution having concentration by mass of potassium hydroxide between 10% and 50%;
g. providing gaseous hydrogen to said anode diffusion layer; and
i. providing gaseous oxygen to said cathode diffusion layer.

12. A method of producing electricity as recited in claim 11, wherein said porous filter paper has a porosity between 5% and 30% by volume.

13. A method of producing an electrical potential as recited in claim 11, further comprising providing a humidifier that regulates the saturation of said alkaline membrane electrolyte with said aqueous potassium hydroxide solution.

14. A method of producing an electrical potential as recited in claim 13, wherein said humidifier is under automatic control.

15. A method of producing an electrical potential as recited in claim 1, wherein a flow of said gaseous hydrogen and a flow of said gaseous oxygen is regulated to provide a desired reaction rate.

16. A method of producing an electrical potential as recited in claim 15, wherein said regulation of said flows is done automatically.

17. A method of producing an electrical potential as recited in claim 11, wherein said oxygen is taken from a supply of air.

18. A method of producing an electrical potential as recited in claim 11, wherein each of said catalysts is selected from the group consisting of nickel, iron, and cobalt.

19. A method of producing an electrical potential as recited in claim 12, wherein each of said catalysts is selected from the group consisting of nickel, iron, and cobalt.

20. A method of producing an electrical potential as recited in claim 13, wherein each of said catalysts is selected from the group consisting of nickel, iron, and cobalt.
